(19) United States
(12) Patent Application Publication
(10) Pub. No.: US 2026/0255178 A1
(43) Pub. Date: Aug. 27, 2026

(54) SYSTEM AND METHOD FOR EVALUATING HEALTH OF A CELL SITE USING A MOBILE APPLICATION

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Amreli (IN); Prashant KHATRI, Betul (IN); Yogeshwar BARGAL, Betul (IN); Nandakishor VALAKUNDE, Pune (IN); Rahul NAGWANI, Indore (IN)

(73) Assignee: JIO PLATFORMS LIMITED, Ahmedabad (IN)

(21) Appl. No.: 18/992,937

(22) PCT Filed: May 10, 2024
(86) PCT No.: PCT/IN2024/050514

§ 371 Date: Jan. 9, 2025

(30) Foreign Application Priority Data
Jun. 29, 2023 (IN) 202321043826

(51) Int. Cl. H04W 16/18; G01S 19/42; H04W 24/08

(52) U.S. Cl. CPC H04W 16/18; G01S 19/42; H04W 24/08

(57) ABSTRACT

The present disclosure provides system (102) and method (300) for evaluating cellular sites through a mobile application. The system (102) employs one or more processors to initiate a sequence of performance tests, such as speed, video quality, web performance, and traceroute tests. A data acquisition module determines the match between site location identifiers, such as NCI, Cell ID, and PCI, and the device-measured identifiers. A global positioning system (GPS) module ensures the testing device's proximity to the cellular site. Test results are compared against predefined Key Performance Indicators (KPIs) for latency, download, and upload speeds by a verification module. The processors then ascertain if the tests satisfy the KPIs. An interface within the application allows for the re-performance of tests if KPIs are not met and displays the overall pass or fail status of the cellular site, streamlining the site assessment process for field engineers.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to communication network. In particular, the present disclosure relates to a system and method for evaluating health of a cell site using a mobile application.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Mobile app-based cell site health check for enabling efficient system monitoring is a comprehensive solution that leverages the power of mobile applications to monitor and optimize the performance of cell sites in a network. This approach offers several benefits and features that enhance the efficiency and effectiveness of system monitoring.

Patent document number U.S. Pat. No. 8,077,098B2 titled “Antenna test system” discloses testing antenna systems using position determination, orientation determination, test pattern analysis using a variety of factors and equipment including positions and orientation of antenna(s) under test at specific points and signal processing systems. Another patent document number U.S. Pat. No. 10,084,673B1 titled “Network speed testing method” discloses automatically determining a MIMO issue at the communications network site based on a comparison of the depth and spread data to pre-defined scenarios.

Conventional systems and methods face difficulty in understanding on which site user wants to perform speed test as the latch is with multiple cell id/NCI/PCI at a time. There is, therefore, a need in the art to provide a method and a system that can overcome the shortcomings of the existing prior arts.

### SUMMARY

The present disclosure discloses a method for assessing performance of cellular sites. The method includes initiating, by one or more processor(s), a test sequence, through an application interface of a user device for executing a plurality of performance tests on a cellular site. The method includes providing, by a global positioning system (GPS) module, a location of the user device. The method includes selecting, by a data acquisition module, at least one site location identifier associated with the user device based on the location of the user device and determining whether the at least one selected site location identifier matches with a set of device-measured identifiers at a particular location. The method includes executing, by a processing engine, at least one performance test in response to a match of site location identifiers and device-measured identifiers. The method includes determining, by the one or more processor(s), a performance of the cellular site based on the executed at least one performance test by comparing test results obtained from the at least one executed performance test against a predefined range of a plurality of Key Performance Indicators (KPIs) stored within a database. The plurality of KPIs includes latency, download speed, upload speed, reference signal received power (RSRP), and signal-to-interference-plus-noise ratio (SINR).

In an embodiment, the determined performance of the cellular site includes a pass status and a fail status. The pass status indicates that the test results obtained from the at least one executed performance test lies in the predefined range of the plurality of KPIs. The fail status indicates that the test results obtained from the at least one executed performance test lies outside the predefined range of the plurality of KPIs.

In an embodiment, the method includes a step of displaying an error message on the application interface of the user device and reperforming the at least one performance test if the determined performance is the fail status.

In an embodiment, the method includes a step of displaying the test results obtained from the at least one executed performance test on the application interface of the user device if the determined performance is the pass status.

In an embodiment, the method includes a step of refreshing the application interface at a predefined interval to ensure updated matching of the site location identifiers with the device-measured identifiers.

In an embodiment, the method includes a step of periodically fetching and updating the site location identifiers from the database. The method includes synchronizing, in real-time, the site location identifiers with the device-measured identifiers to facilitate immediate test execution upon matching.

In an embodiment, the method includes a step of automatically recording the test results for each performance test executed and comparing the automatically recorded test results with historical data stored in the database to determine at least one of one or more trends and one or more performance improvement KPIs over time.

The present disclosure discloses a system for assessing performance of cellular sites. The system includes one or more processor(s), a global positioning system (GPS) module, a data acquisition module, a processing engine, a verification module, and an interface(s). The one or more processor(s) is configured to initiate a test sequence through an application interface of a user device for executing a plurality of performance tests on a cellular site. The GPS module is configured to provide a location of the user device. The data acquisition module is configured to select at least one site location identifier associated with the user device based on the location of the user device and is further configured to determine whether the at least one selected site location identifier matches with a set of device-measured identifiers at a particular location. The processing engine is configured to execute at least one performance test in response to a match of site location identifiers and device-measured identifiers and is further configured to determine a performance of the cellular site based on the executed at least one performance test by comparing test results obtained from the at least one executed performance test against a predefined range of a plurality of Key Performance Indicators (KPIs) stored within a database. The plurality of KPIs includes latency, download speed, upload speed, reference signal received power (RSRP), and signal-to-interference-plus-noise ratio (SINR).

In an embodiment, the determined performance of the cellular site includes a pass status and a fail status. The pass status indicates that the test results obtained from the at least one executed performance test lies in the predefined range of the plurality of KPIs. The fail status indicates that the test results obtained from the at least one executed performance test lies outside the predefined range of the plurality of KPIs.

In an embodiment, the system is configured to display an error message on the application interface of the user device and reperform the at least one performance test if the determined performance is the fail status.

In an embodiment, the system is configured to display the test results obtained from the at least one executed performance test on the application interface of the user device if the determined performance is the pass status.

In an embodiment, the at least one selected site location identifier is selected from a group consisting of an NCI (Network Cell Identity), a Cell ID, and a PCI (Physical Cell ID).

In an embodiment, the at least one performance test is selected from the group consisting of a speed test, a video test, a web performance test, and a traceroute test.

In an embodiment, the GPS module is further configured to verify whether the user device is in proximity to the cellular site corresponding to the at least one matched site location identifier.

The In an embodiment, the one or more processor(s) are further configured to refresh the application interface at a predefined interval to ensure updated matching of the site location identifiers with the device-measured identifiers.

In an embodiment, the data acquisition module is further configured to periodically fetch and update the site location identifiers from the database and synchronize, in real-time, the site location identifiers with the device-measured identifiers to facilitate immediate test execution upon matching.

In an embodiment, the processing engine is further configured to automatically record the test results for each performance test executed and compare the automatically recorded test results with historical data stored in the database to determine at least one of one or more trends and one or more performance improvement KPIs over time.

The present disclosure discloses a user equipment (UE) configured to assess performance of cellular sites. The user equipment includes a processor in and a computer readable storage medium storing programming for execution by the processor. The programming including instructions to initiate a test sequence through an application interface of the user equipment (UE) for executing a plurality of performance tests on a cellular site, receive a location of the user equipment (UE) from a global positioning system (GPS) module, select at least one site location identifier associated with the user device based on the location of the user equipment and is further configured to determine whether the at least one selected site location identifier matches with a set of equipment-measured identifiers at a particular location, execute at least one performance test in response to a match of site location identifiers and equipment-measured identifiers, and determine a performance of the cellular site based on the executed at least one performance test by comparing test results obtained from the at least one executed performance test against a predefined range of a plurality of Key Performance Indicators (KPIs) stored within a database. The plurality of KPIs includes latency, download speed, upload speed, reference signal received power (RSRP), and signal-to-interference-plus-noise ratio (SINR).

In an embodiment, the determined performance of the cellular site includes a pass status and a fail status. The pass status indicates that the test results obtained from the at least one executed performance test lies in the predefined range of the plurality of KPIs. The fail status indicates that the test results obtained from the at least one executed performance test lies outside the predefined range of the plurality of KPIs.

In an embodiment, the user equipment (UE) is configured to display an error message on the application interface of the user device and reperform the at least one performance test if the determined performance is the fail status.

In an embodiment, the user equipment (UE) is configured to display the test results obtained from the at least one executed performance test on the application interface of the user device if the determined performance is the pass status.

In an embodiment, the processor is further configured to refresh the application interface at a predefined interval to ensure updated matching of the site location identifiers with the device-measured identifiers.

### OBJECTS OF THE PRESENT DISCLOSURE

Some of the objects of the present disclosure, which at least one embodiment herein satisfies are as listed herein below.

An object of the present disclosure is to provide a system and a method for evaluating health of a cell site using a mobile application.

An object of the present disclosure is to provide real-time monitoring of cell site health, providing instant updates and notifications about any issues or anomalies.

An object of the present disclosure is to eliminate the need for manual documentation and reduces the time required to collect and analyse data, leading to improved operational efficiency.

An object of the present disclosure is to collect data through mobile application-based monitoring which can be analysed to gain valuable insights into cell site performance trends, patterns, and potential areas for optimization.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary architecture of a system for assessing performance of cellular sites, in accordance with embodiments of the present disclosure.

FIG. 2 illustrates an exemplary micro service-based architecture of the system, in accordance with embodiments of the present disclosure.

FIG. 3 illustrates an exemplary flow diagram of a method for assessing performance (evaluating health) of a cellular site using an interface application, in accordance with embodiments of the present disclosure.

FIGS. 4A-4D illustrate an exemplary user interface representing health of the cellular site using an interface application, in accordance with embodiments of the present disclosure.

FIG. 5 illustrates an exemplary computer system in which or with which embodiments of the present disclosure may be implemented.

The foregoing shall be more apparent from the following more detailed description of the disclosure.

### LIST OF REFERENCE NUMERALS

100—Network Architecture
102—System
104—Network
106—Centralized Server
108-1, 108-2 . . . 108-N—User Equipments
110-1, 110-2 . . . 110-N—Users
202—One or more processor(s)
204—Memory
206—A Plurality of Interfaces
208—Processing Engine
210—Data Acquisition Module
212—Verification Module
214—Global Positioning System (GPS) Module
216—Other Module(s)
218—Database
510—External Storage Device
520—Bus
530—Main Memory
540—Read Only Memory
550—Mass Storage Device
560—Communication Port
570—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, network planning process is completely manual and undefined. Radio engineers are required to perform all the tedious tasks of data collection, post-processing, analysis, and radio prediction on their desktops. In the traditional approach, it is not possible to make use of the power of huge crowdsourced and rich geospatial datasets. Multiple iterations are required with varying inputs to arrive at the best site plan. This traditional approach is manual, tedious, and poses several challenges. The present disclosure simplifies the network planning process by automating and integrating all the necessary components. With the present disclosure, radio engineers are provided with all the inputs required for planning in less time and obtain an optimal list of sites/cells.

The present disclosure serves the purpose of evaluating health of a cellular site (also referred as a network site or a cell site) using a mobile application (application interface). The system and method is configured to detect Network Cell Information (NCI)/Cell ID/physical cell ID (PCI) corresponding to a cell site in telecom network. Generally, in telecom when a user (network operator) wants to perform any speed/Video/Web performance/Trace route test on any particular site/cell, the present disclosure provides a facility to the user to initiate the accessing performance test when the NCI/Cell ID/PCI connected with user device is matched with the NCI/Cell ID/PCI corresponding to the cell site in the network. The user can measure all required parameters like uplink, download link, latency corresponding to the network site (detected using NCI/Cell ID/PCI), thereby enabling the user to perform extended test (like Video and Web performance test) on given cell site.

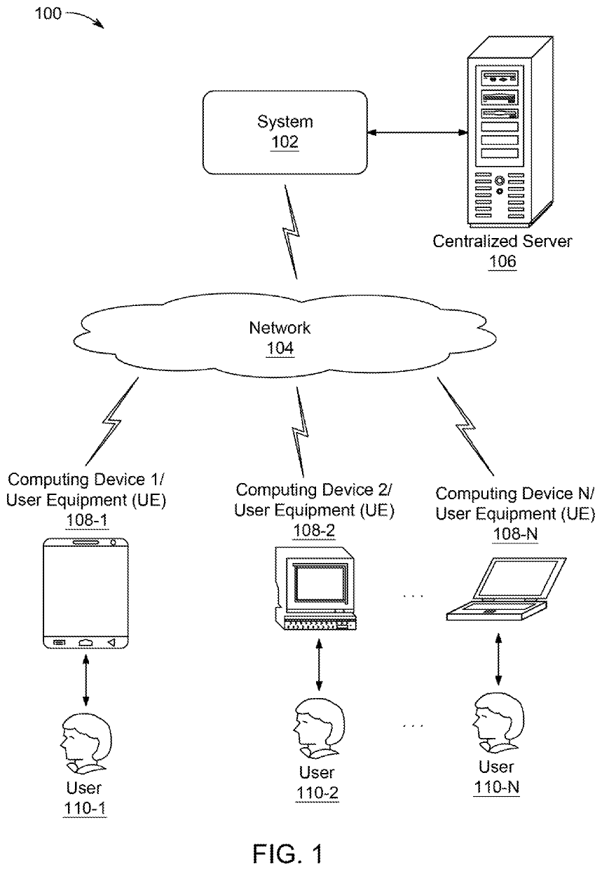

The various embodiments throughout the disclosure will be explained in more detail with reference to FIG. 1-FIG. 5.

FIG. 1 illustrates an exemplary architecture 100 of a system (102) for assessing performance of cellular sites, in accordance with embodiments of the present disclosure. In an example, the system is configured to evaluate health of a cell site using a mobile application or an interface application.

Referring to FIG. 1 the network architecture 100 is implemented for enabling speed test of internet connection using the interface application (mobile application). In an embodiment, the system (102) is connected to a network 104, which is further connected to at least one computing devices 108-1, 108-2, . . . 108-N (collectively referred as computing device 108, herein) associated with one or more users 110-1, 110-2, . . . 110-N (collectively referred as user (110), herein). The computing device 108 may be personal computers, laptops, tablets, wristwatch, or any custom-built computing device integrated within a modern diagnostic machine that can connect to a network as an IoT (Internet of Things) device. In an embodiment, the computing device 108 may also be referred to as User Equipment (UE) or user device. Accordingly, the terms “computing device” and “User Equipment” may be used interchangeably throughout the disclosure. In an aspect, the user (110) is a network operator or a field engineer. Further, the network 104 can be configured with a centralized server 106 that stores compiled data.

In an embodiment, the system (102) may receive at least one input data from the user (110) via the at least one computing devices 108. In an aspect, the user (110) may be configured to initiate a test sequence for executing a plurality of performance tests on a cellular site, through an application interface of a mobile application installed in the computing devices 108. The mobile application may be configured to communicate with the network analysis server. In some examples, the mobile application may be a software or a mobile application from an application distribution platform. Examples of application distribution platforms include the App Store for iOS provided by Apple, Inc., Play Store for Android OS provided by Google Inc., and such application distribution platforms. In an embodiment, the computing device 108 may transmit the at least one captured data packet over a point-to-point or point-to-multipoint communication channel or network 104 to the system (102).

In an embodiment, the computing device 108 may involve collection, analysis, and sharing of data received from the system (102) via the network 104.

In an exemplary embodiment, the network 104 may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the network 104 may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

A layout of the output end of the system (102) is described, as it may be implemented. The system (102) can be configured to enable common solution for mobile and web, download speed, upload speed, ping test, server selection, and data sharing.

In an embodiment, the system (102) is configured to retrieve a location of the user (110) and based on the retrieve location, system (102) is configured to detect at least one parameter associated with the cellular site. In an aspect, the at least one parameter Network Cell Information (NCI)/Cell ID/physical cell ID (PCI). Generally, in telecom when the user (110) wants to perform any speed/Video/Web performance/Trace route test on any particular site/cell. On detecting at least one parameter associated with the cellular site, the system is further configured to initiate the assessment of the network automatically, thereby providing a facility to the user (110) to initiate a test when the desired NCI/Cell ID/PCI connected with user device. The user (110) can measure all required parameters like uplink, download link, and latency on that NCI/Cell ID/PCI; by using this feature, the user (110) can perform extended tests on a given site like (Video and Web performance tests).

The interface application is installed on the computing device. Further, the interface application is helpful in site commissioning process, where the user (110) (site engineer) needs to perform speed test, Video and Web and Traceroute test on any particular network cell having a particular NCI/Cell ID/PCI value.

In an embodiment, the system (102) checks the performance of sites with different tests (like Speed test, video test, web performance test and traceroute) using the interface application. Further, the system (102) enhances the capability of the user (110) to connect on dedicated sites for real time observation. The system provides Ad-Hoc and work order-based test on sites. In the Ad-hoc test, the user (110) is able to select the desired value of site parameters, and when this value matches the site's parameter, the interface application provides a facility to perform a test on the selected Cell ID/NCI ID/PCI. In the Work Order with automation (work order-based test), an admin can configure site details on which the user (110) needs to perform the test. When a site engineer visits the network site and a predefined configure value matches the site's parameters, the interface application provides the facility to perform the test. In Automation process, the admin can define/set the range of any KPI. If after executed test, result matched with the define KPI, then the interface application considers executed test is Passed and if value did not match with the predefined KPI values, then the interface application shows the executed test is failed. For example, Table 1 depicts an approximate range of the Key Performance Indicators (KPIs) and its status.

TABLE 1

| KPI | Range | | Status |
|---|---|---|---|
| Latency | 0 to 25 | ms | Pass |
| Latency | >25 | ms | Fail |
| Download Speed | >50 | Mbps | Pass |
| Download Speed | <50 | Mbps | Fail |
| Upload Speed | >25 | Mbps | Pass |
| Upload Speed | <25 | Mbps | Fail |

Further, the system (102) provides accuracy of field engineer for correct site commissioned. The system (102) provides an automatic process of detecting Cell ID/NCI/PCI and verifying it from a backend database, which is an automatic solution with predefined criteria of deciding whether network site considered to be pass or fail. The system (102) helps the field engineer to take perform speed test on desire site test after deploying site installation on the field.

In an embodiment, the system (102) provides accuracy by matching exact values of PCI/NCI/Cell ID in the interface application with PCI/NCI/Cell ID values predefined in backend for that site. Hence, the system (102) avoids manual intervention of the field engineer. If the automatic detection of the network site is failed, in such scenario, a manual latching/locking to the network site is provided where the user (110) can latch to required Cell ID/NCI/PCI based on the user's location.

When an output is received after the execution of the test, the user (110) can understand speed of the network predicated by the system (102), as well as take steps to prevent further degradation of speed of the network based on suggested recommendations.

In an embodiment, the network 104 is further configured with a centralized server 106 including a database, where all output (executed tests) is stored. The results can be retrieved whenever there is a need to generate a trend representing changes in the KPIs in future. By generating the trends(s), the user can identify one or more trends and one or more performance improvement KPIs over time. This analysis helps in better understanding the overall performance of the network being tested and also helps in identifying areas that need improvement. The historical data serves as a baseline for comparison and helps in identifying any deviation from the expected performance. By monitoring these trends and KPIs over time, the user can identify patterns and make informed decisions to improve the system's overall performance.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

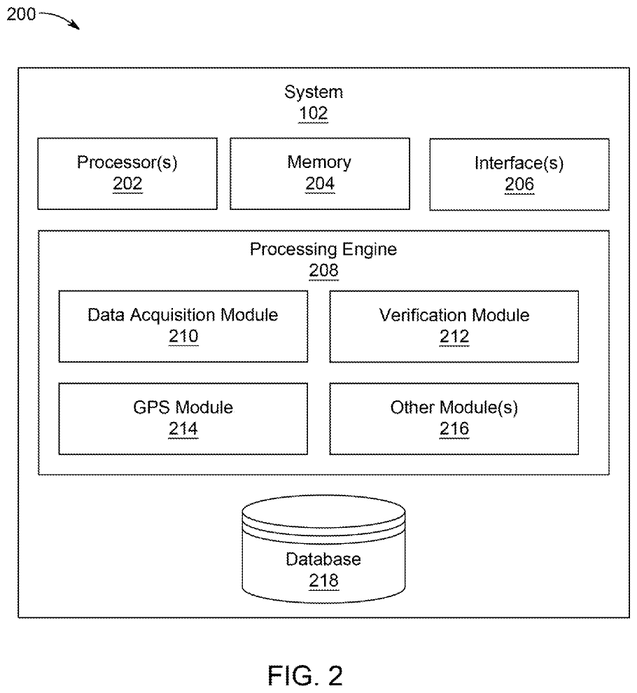

FIG. 2 illustrates an exemplary micro service-based architecture 200 of the system (102), in accordance with embodiments of the present disclosure.

FIG. 2 with reference to FIG. 1, illustrates an exemplary representation of the system (102) for enabling speed test of internet connection using the mobile application, in accordance with an embodiment of the present disclosure.

The system (102) includes one or more processor(s) (202), a memory (204), a processing engine (208), a database (218), and an interface(s) (206). In an exemplary embodiment, the processing engine (208) may include one or more engines selected from any of a data acquisition module 210, a verification module 212, a GPS module 214, and other modules 216 having functions that may include but are not limited to testing, storage, and peripheral functions, such as wireless communication unit for remote operation, audio unit for alerts and the like.

The one or more processor(s) (202) is configured to initiate a test sequence through the application interface of the user device. In an embodiment, the application interface is configured to execute a plurality of performance tests on the cellular site.

The GPS module (214) is configured to provide a location of the user device. In an example, the global positioning system (GPS) module is configured to generate coordinates with respect to the location of the user device. The one or more processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in the memory 204 of the system (102). The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random Access Memory (RAM), or non-volatile memory such as Erasable Programmable Read-Only Memory (EPROM), flash memory, and the like.

The interface(s) (206) is included within the system (102) to serve as a medium for data exchange, configured to facilitates user interaction with the mobile application and the execution of performance tests. The interface(s) (206) may be composed of interfaces for data input and output devices, storage devices, and the like, providing a communication pathway for the various components of the system (102).

The interface(s) 206 may comprise a variety of interfaces, for example, interfaces for data input and output devices, referred to as I/O devices, storage devices, and the like. The interface(s) 206 may facilitate communication to/from the system (102). The interface(s) 206 may also provide a communication pathway for one or more components of the system (102). Examples of such components include but are not limited to, the processing unit/engine(s) (208) and the database 218.

The processing engine (208), encompassing the data acquisition module 210, is the component that handles the matching of site location identifiers with the device-measured identifiers. An example includes using the mobile application to scan a QR code at the cellular site, which contains the NCI/Cell ID/PCI information. The data acquisition module (210) is configured to select at least one site location identifier associated with the user device based on the location of the user device and is further configured to determine whether the at least one selected site location identifier matches with a set of device-measured identifiers at a particular location. In an embodiment, the at least one selected site location identifier is selected from a group consisting of an NCI ((NR Cell Identity), a Cell ID, and a PCI (Physical Cell ID).

The data acquisition module 210 then compares the scanned information with the identifiers within the mobile device to confirm a match. The processing engine (208) is configured to execute at least one performance test in response to a match of site location identifiers and device-measured identifiers. In an embodiment, the at least one performance test is selected from the group consisting of a speed test, a video test, a web performance test, and a traceroute test. In an embodiment, the GPS module is further configured to verify whether the user device is in proximity to the cellular site corresponding to the at least one matched site location identifier. The GPS module (214) utilizes satellite-based positioning to ascertain the precise location of the mobile application relative to the cellular site. In an aspect, the data acquisition module is further configured to periodically fetch and update the site location identifiers from the database and synchronize, in real-time, the site location identifiers with the device-measured identifiers to facilitate immediate test execution upon matching.

In an embodiment, the processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (102) may comprise the machine-readable storage medium storing the instructions and the processing resource to execute the instructions, or the machine-readable storage medium may be separate but accessible to the system (102) and the processing resource. In other examples, the processing engine(s) (208) may be implemented by electronic circuitry.

The processing engine (208), via the verification module (212), is configured to compare test results obtained from the at least one executed performance test against a predefined range of a plurality of Key Performance Indicators (KPIs) stored within a database (218). The plurality of KPIs includes latency, download speed, upload speed, reference signal received power (RSRP), and signal-to-interference-plus-noise ratio (SINR). The one or more processor(s) (202) is further configured to determine, based on the comparison by the verification module (212), whether the at least one executed performance test meets the predefined range of the plurality of KPIs. The processing engine is configured to determine the performance of the cellular site based on the executed at least one performance test by comparing test results obtained from the at least one executed performance test against a predefined range of a plurality of Key Performance Indicators (KPIs) stored within the database. In an example, the determined performance of the cellular site includes a pass status and a fail status. The pass status indicates that the test results obtained from the at least one executed performance test lie in the predefined range of the plurality of KPIs. The fail status indicates that the test results obtained from at least one executed performance test lie outside the predefined range of the plurality of KPIs. For example, for the latency test, the test result (for example, the latency KPI) obtained from the executed latency test is a value of 60 ms. In an aspect, the predefined range of the latency KPI is 0-50 ms. In an example, the predefined range may be a configurable range. Other exemplary predefined ranges not disclosed are contemplated herein. When the test result of the executed latency test is 60 ms, the determined performance result will fail, as it lies beyond the predefined range. For example, if the test result obtained from the executed latency test shows a value of 32 ms, then the test result obtained from the executed latency test lies within the predefined range; therefore, the determined performance result will be passed.

The system (102) is configured to display an error message on the application interface of the user device (110). The interface(s) (206) is configured to reperform the at least one performance test if the test results of the at least one executed performance test do not meet the predefined range of the plurality of KPIs (the determined performance is the fail status). If the determined performance is the pass status, the test results obtained from the at least one executed performance test is displayed on the application interface of the user device.

The one or more processor(s) (202) are further configured to refresh the application interface at a predefined interval to ensure updated matching of the site location identifiers with the device-measured identifiers.

In an embodiment, the processing engine is further configured to automatically record the test results for each performance test executed in the database. The processing engine is further configured to compare the automatically recorded test results (new updated result) with historical data stored in the database to determine at least one of one or more trends and one or more performance improvement KPIs over time. In an aspect, based upon the determined trends, the network operator may be configured to calculate site and resource utilization and further plan the resources according to the determined trends in an efficient way.

In an embodiment, the database (218) is configured for serving as a centralized repository for storing and retrieving various operational data, including but not limited to the predefined KPIs, historical test results, and site location identifiers. The database (218) is designed to interact seamlessly with other components of the system (102), such as the data acquisition module (210) and the verification module (212), to support the system's functionality effectively. The database 218 may store data that may be either stored or generated as a result of functionalities implemented by any of the components of the processor 202 or the processing engines (208). In an embodiment, the database 218 may be separate from the system (102).

In an embodiment, the one or more processor(s) (202) are further configured to refresh the application interface at a predefined interval to ensure updated matching of the site location identifiers with the device-measured identifiers and trigger a test reperform option in the application interface if the test results do not meet the predefined range of the plurality of KPIs.

In an embodiment, the interface(s) (206) is further configured to display real-time updates of the test execution status and results and enable notifications for the field engineer regarding the status of the matching process and the availability of the test execution option.

The data acquisition module (210) is configured to periodically fetch and update the site location identifiers from the database (218) to ensure that the test execution conditions are accurate and up-to-date.

The verification module (212) is integrated into the processing engine (208) and is configured to compare the results obtained from the executed performance tests against a range of predefined Key Performance Indicators (KPIs) stored within a database (218). The verification module (212) is configured for automatically recording the test results for each performance test executed. The verification module (212) also compares these results with historical data stored in the database (218), enabling the system (102) to determine trends and performance improvements over time. This comparative analysis is vital for continuous improvement and quality assurance in cellular site performance. The KPIs encompass metrics such as latency, download speed, upload speed, reference signal received power (RSRP), and signal-to-interference-plus-noise ratio (SINR), critical for assessing the performance of the cellular site.

In one embodiment, the one or more processor(s) (202) are also configured to refresh the mobile application interface at predefined intervals, ensuring that the site location identifiers are consistently updated to match with the device-measured identifiers. This mechanism is crucial for maintaining the accuracy and reliability of the performance tests conducted by the mobile application.

In one aspect, the interface(s) (206) also includes a user interaction element within the mobile application, which is configured to enable the reperform the one or more performance tests if the initial test results do not align with the predefined KPIs. This feature ensures that the system (102) can dynamically respond to test outcomes, allowing field engineers to take immediate corrective actions when necessary.

In one aspect, the interface(s) (206) further enhance the user experience by providing the application interface that displays real-time updates of the test execution status and results. Additionally, the interface(s) (206) enable the system (102) to provide notifications to the field engineer about the status of the matching process and the availability of the test execution options.

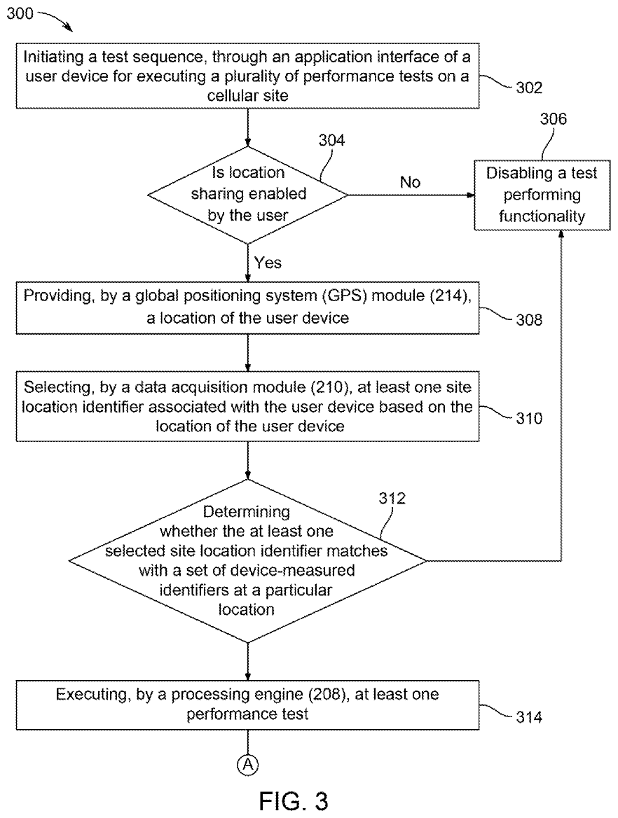

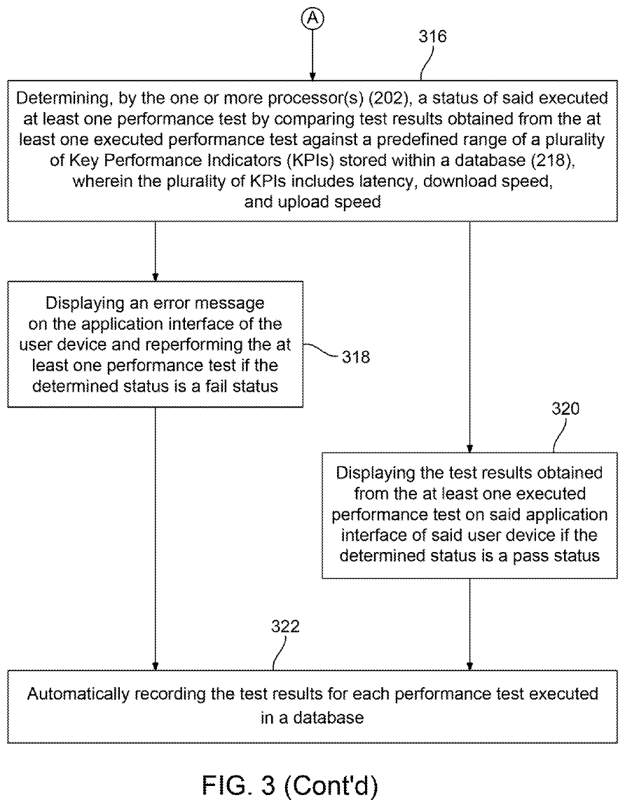

FIG. 3 illustrates an exemplary flow diagram of a method 300 for assessing performance or evaluating health of the cellular site using the mobile application (application interface), in accordance with embodiments of the present disclosure.

At step 302, the one or more processor(s) (202) is configured to initiate a test sequence, through an application interface of the user device for executing a plurality of performance tests on the cellular site. In an operative aspect, when the field engineer visits a place for measuring a performance of the cellular site, then using the application interface installed in the user device (computing device), he starts the method for assessing performance or evaluating health of the cellular site.

At step 304, the one or more processor(s) (202) is configured to determine whether location sharing is enabled by the user (110). If the location sharing is disabled on the user device, then the one or more processor(s) (202) is configured to disable a test for assessing performance or evaluating health of the cellular site (step 306). In an aspect, the one or more processor(s) (202) is configured to display a notification to the user (110) for enabling the location sharing for performing the performance test. If location sharing is enabled, the global positioning system (GPS) module is configured to provide a location of the user device (step 308). In an example, the global positioning system (GPS) module is configured to generate coordinates with respect to the location of the user device.

At step 310, the data acquisition module selects at least one site location identifier associated with the user device based on the location of the user device. For example, after receiving the coordinates of the location of the user device the data acquisition module is configured to search the cellular site corresponding to the received coordinates. The data acquisition module is further configured to select the at least one site location identifier corresponding to the cellular site. In an example, the at least one selected site location identifier is selected from a group consisting of an NCI ((NR Cell Identity), a Cell ID, and a PCI (Physical Cell ID).

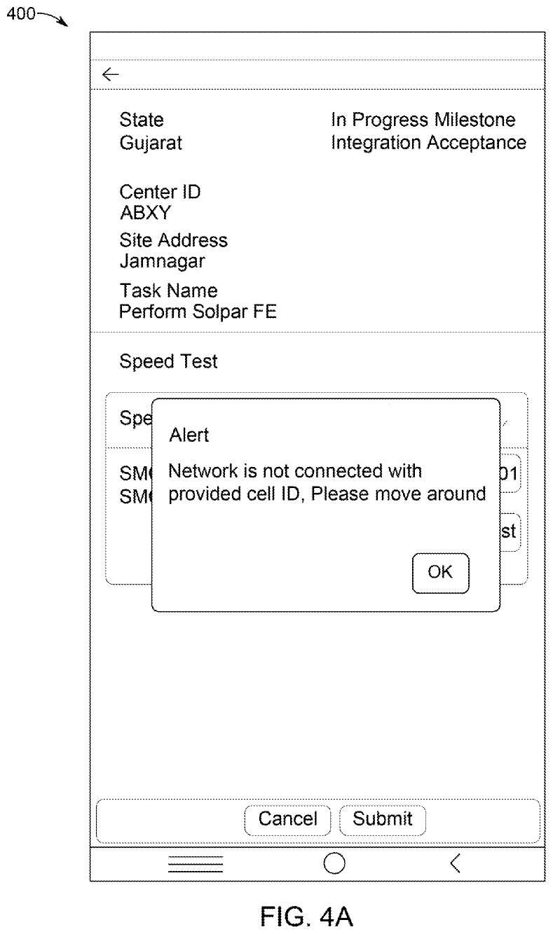

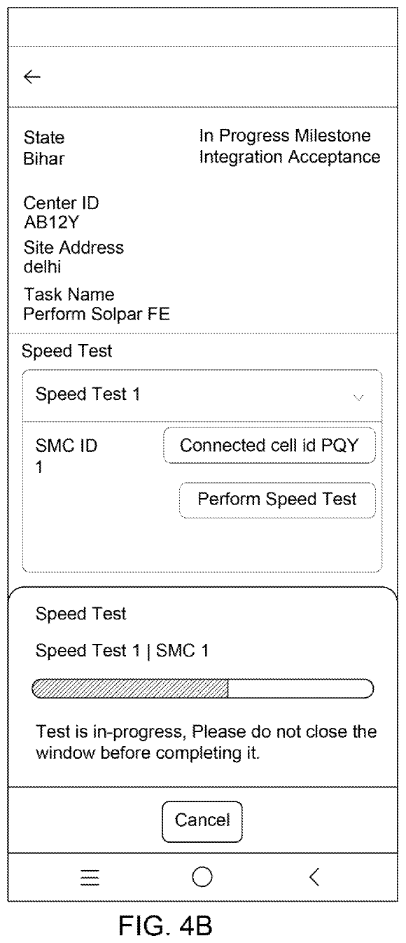

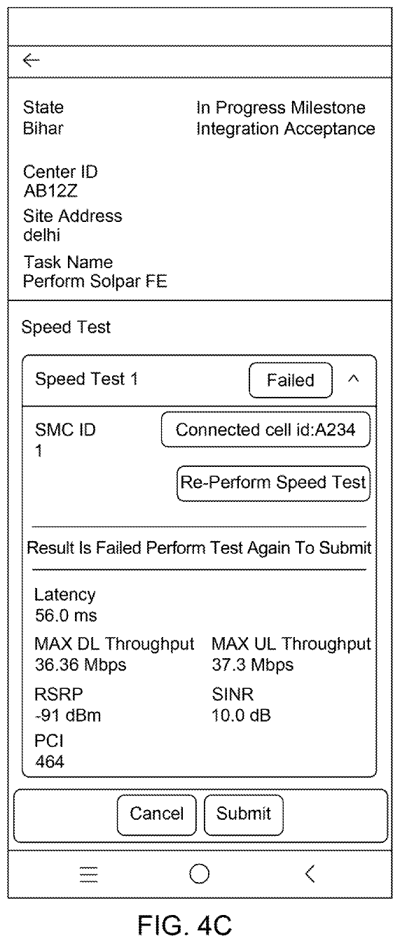

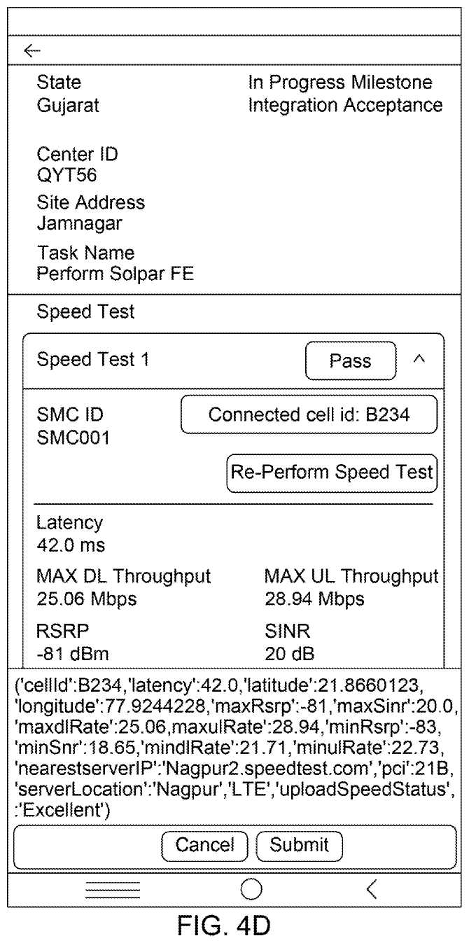

At step 312, the data acquisition module is configured to determine whether the at least one selected site location identifier matches with a set of device-measured identifiers at a particular location. In an example, the value of cell associated with the user device is 1 (having SMC (Small Modular Cell) id=1) and it is matched with a cell ID 112 (as shown in FIG. 4B). Then the application interface asked the user to perform the test. If the network associated with the set of device-measured identifiers did not match with any at least one selected site location identifier, then the application interface may be configured to display a message on the screen saying that “network is not connected with the provided cell ID, kindly move around” (as shown in FIG. 4A).

At step 314, the processing engine is configured to execute at least one performance test in response to a match of site location identifiers and device-measured identifiers. For example, the at least one performance test is selected from the group consisting of a speed test, a video test, a web performance test, and a traceroute test. In an example, the application interface is configured to display a list of the performance test(s). During the speed test, the system (102) measures the speed of an internet connection, providing insights into the download and upload speeds as well as latency. The speed test is crucial for identifying potential issues in the connection, helping users optimize their internet performance. During the video test, the system (102) assesses the capability of an internet connection to smoothly stream video content. The results of the video test give the user (110) an indication of their connection's ability to handle streaming services, ensuring a seamless and enjoyable multimedia experience. During the web performance tests, the system (102) evaluates the efficiency of a website's loading speed and overall performance. The web performance tests analyze various factors, including server response time, render-blocking resources, and image optimization. During the traceroute test, the system (102) maps the route that data packets take from the source to a destination, revealing the latency and response times at each intermediate point.

At step 316, the one or more processor(s) (202) is configured to determine a performance of the cellular site based on the executed at least one performance test by comparing test results obtained from the at least one executed performance test against a predefined range of a plurality of Key Performance Indicators (KPIs) stored within a database. The plurality of KPIs includes latency, download speed, upload speed, reference signal received power (RSRP), and signal-to-interference-plus-noise ratio (SINR). The determined performance of the cellular site includes a pass status and a fail status. The pass status indicates that the test results obtained from the at least one executed performance test lies in the predefined range of the plurality of KPIs. The fail status indicates that the test results obtained from the at least one executed performance test lies outside the predefined range of the plurality of KPIs.

At step 318, the one or more processor(s) (202) is configured to display an error message on the application interface of the user device and reperforming the at least one performance test if the determined performance is the fail status.

At step 320, the one or more processor(s) (202) is configured to display the test results obtained from the at least one executed performance test on the application interface of the user device if the determined performance is the pass status.

At step 322, the one or more processor(s) (202) is configured to display automatically recording the test results for each performance test executed and comparing the automatically recorded test results with historical data stored in the database to determine at least one of one or more trends and one or more performance improvement KPIs over time.

The method further includes a step of refreshing the application interface at a predefined interval to ensure updated matching of the site location identifiers with the device-measured identifiers.

The method further includes a step of periodically fetching and updating the site location identifiers from the database. The method includes synchronizing, in real-time, the site location identifiers with the device-measured identifiers to facilitate immediate test execution upon matching.

In an operative aspect, the field engineer visits the location, and it is determined that whether the location is enabled or not on the user device. If the location is enabled, the site commissioning process measures DL UL, latency, and network parameters when NCI/Cell ID/PCI values of the site location and device measured NCI/Cell ID/PCI value at a particular location are matched. Upon matching, the test is performed. The test includes a speed test, a video test, a web performance test, a traceroute test, and the like. To match with the site's NCI/Cell ID/PCI, screen will keep on refreshing itself after a pre-defined interval, for example, every 5 minutes. After click on perform icon test will be initiated and captured all KPI. After test successfully executed this result matched with expected result. If result not matched user (110) will get “Re-performed” button. Test result data is stored in a database. The data will be aggregated and method of evaluating sites is performed. After the aggregation, the based on the evaluation result, the system (102) determines whether the site “passed” or “failed” the test. The results are then displayed on the application installed on the user's equipment, initiating the process cycle again.

If the value of NCI/Cell ID/PCI of the user device has not matched with the identifiers of the cellular site, then also the test performing functionality is disabled.

FIGS. 4A-4D illustrate an exemplary user interface representing health of a cell site using the mobile application, in accordance with embodiments of the present disclosure.

In an embodiment, FIGS. 4A-4D disclose a user interface representing the speed test of the internet connection. FIG. 4A is a representation 400 of a failure of the test, due to connection failure. FIG. 4B is a representation 410 of connecting to the cell ID and checking the site health by the mobile application. FIG. 4C is a representation 420 of an output of the successful speed test 1. FIG. 4D is a representation 430 of an output of the successful speed test 2.

In an exemplary embodiment, the present disclosure discloses a user equipment which is configured to assess performance of cellular sites. The user equipment includes a processor, and a computer readable storage medium storing programming instructions for execution by the processor. Under the programming instructions, the processor is configured to initiate a test sequence through an application interface of the user equipment (UE) for executing a plurality of performance tests on a cellular site. The processor is configured to receive a location of the user equipment (UE) from a global positioning system (GPS) module. The processor is configured to select at least one site location identifier associated with the user device based on the location of the user equipment and is further configured to determine whether the at least one selected site location identifier matches with a set of equipment-measured identifiers at a particular location. The processor is configured to execute at least one performance test in response to a match of site location identifiers and equipment-measured identifiers. The processor is configured to determine a performance of a cellular site based on the executed at least one performance test by comparing test results obtained from the at least one executed performance test against a predefined range of a plurality of Key Performance Indicators (KPIs) stored within a database. The plurality of KPIs includes latency, download speed, upload speed, reference signal received power (RSRP), and signal-to-interference-plus-noise ratio (SINR).

In an aspect, the determined performance of the cellular site includes a pass status and a fail status. The pass status indicates that the test results obtained from the at least one executed performance test lies in the predefined range of the plurality of KPIs. The fail status indicates that the test results obtained from the at least one executed performance test lies outside the predefined range of the plurality of KPIs.

In an aspect, the user equipment is configured to display an error message on the application interface of the user device and reperform the at least one performance test if the determined performance is the fail status.

In an aspect, the user equipment is configured to display the test results obtained from the at least one executed performance test on the application interface of the user device if the determined performance is the pass status.

In an aspect, the processor is further configured to refresh the application interface at a predefined interval to ensure updated matching of the site location identifiers with the device-measured identifiers.

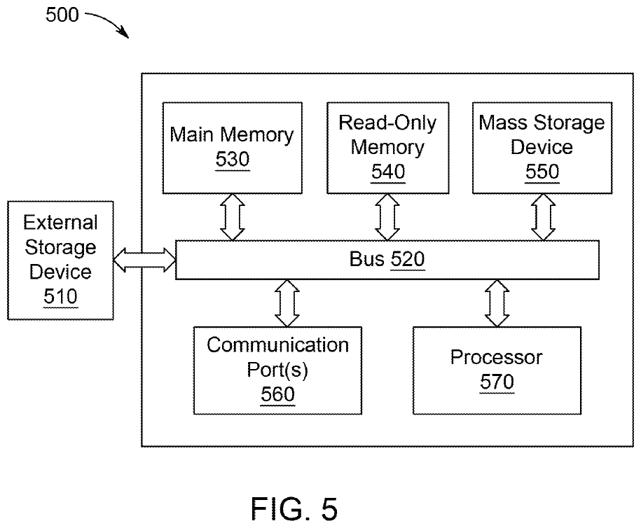

FIG. 5 illustrates an exemplary computer system 500 in which or with which embodiments of the present disclosure may be implemented.

As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 560 may be chosen depending on a network, such a Local Area Network (LAN), Wide Area Network (WAN), or any network to which the computer system 500 connects. The main memory 530 may be random access memory (RAM), or any other dynamic storage device commonly known in the art. The read-only memory 540 may be any static storage device(s) including, but not limited to, a Programmable Read Only Memory (PROM) chips for storing static information e.g., start-up or basic input/output system (BIOS) instructions for the processor 570. The mass storage device 550 may be any current or future mass storage solution, which may be used to store information and/or instructions.

The bus 520 communicatively couples the processor 570 with the other memory, storage, and communication blocks. The bus 520 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 570 to the computer system 500.

Optionally, operator and administrative interfaces, e.g. a display, keyboard, and a cursor control device, may also be coupled to the bus 520 to support direct operator interaction with the computer system 500. Other operator and administrative interfaces may be provided through network connections connected through the communication port(s) 560. In no way should the aforementioned exemplary computer system 500 limit the scope of the present disclosure.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides a system and a method for evaluating health of a cell site using a mobile application.

The present disclosure provides real-time monitoring of cell site health, providing instant updates and notifications about any issues or anomalies.

The present disclosure eliminates the need for manual documentation and reduces the time required to collect and analyse data, leading to improved operational efficiency.

The present disclosure collect data through mobile application-based monitoring which can be analysed to gain valuable insights into cell site performance trends, patterns, and potential areas for optimization.

1. A method for assessing performance of cellular sites,
the method comprising the steps of:
initiating, by one or more processor(s), a test sequence through an application interface of a user device for executing a plurality of performance tests on a cellular site;
providing, by a global positioning system (GPS) module, a location of the user device;
selecting, by a data acquisition module, at least one site location identifier associated with the user device based on the location of the user device and determining whether the at least one selected site location identifier matches with a set of device-measured identifiers at a particular location;
executing, by a processing engine ((208)), at least one performance test in response to a match of the at least one site location identifier and the set of device-measured identifiers; and
determining, by the processing engine, a performance of the cellular site based on the at least one executed performance test by comparing test results obtained from the at least one executed performance test against a predefined range of a plurality of Key Performance Indicators (KPIs) stored within a database, wherein the plurality of KPIs includes a latency, a download speed, an upload speed, a reference signal received power (RSRP), and an signal-to-interference-plus-noise ratio (SINR).

2. The method of claim 1, wherein the determined performance of the cellular site includes a pass status and a fail status, wherein:
the pass status indicates that the test results obtained from the at least one executed performance test lie in the predefined range of the plurality of KPIs; and
the fail status indicates that the test results obtained from the at least one executed performance test lie outside the predefined range of the plurality of KPIs.

3. The method of claim 1, further comprising displaying an error message on the application interface of the user device and reperforming the at least one performance test if the determined performance is the fail status.

4. The method of claim 1, further comprising displaying the test results obtained from the at least one executed performance test on the application interface of the user device if the determined performance is the pass status.

5. The method of claim 1, further comprising:
refreshing the application interface at a predefined interval to ensure updated matching of the at least one site location identifier with the set of device-measured identifiers.

6. The method of claim 1, further comprising:
periodically fetching and updating the at least one site location identifier from the database; and
synchronizing, in real-time, the at least one site location identifier with the set of device-measured identifiers to facilitate immediate execution of the at least one performance test upon matching.

7. The method of claim 1, further comprising:
automatically recording the test results for each performance test executed; and
comparing the automatically recorded test results with historical data stored in the database to determine at least one of one or more trends and one or more performance improvement KPIs over time.

8. A system for assessing performance of cellular sites, the system comprising:
one or more processor(s) configured to initiate a test sequence through an application interface of a user device for executing a plurality of performance tests on a cellular site;
a global positioning system (GPS) module configured to provide a location of the user device;
a data acquisition module configured to select at least one site location identifier associated with the user device based on the location of the user device and is further configured to determine whether the at least one selected site location identifier matches with a set of device-measured identifiers at a particular location;
a processing engine configured to execute at least one performance test in response to a match of the at least one site location identifier and the set of device-measured identifiers and is further configured to determine a performance of the cellular site based on the at least one executed performance test by comparing test results obtained from the at least one executed performance test against a predefined range of a plurality of Key Performance Indicators (KPIs) stored within a database, wherein the plurality of KPIs includes a latency, a download speed, an upload speed, a reference signal received power (RSRP), and a signal-to-interference-plus-noise ratio (SINR).

9. The system of claim 8, wherein the determined performance of the cellular site includes a pass status and a fail status, wherein:
the pass status indicates that the test results obtained from the at least one executed performance test lie in the predefined range of the plurality of KPIs; and
the fail status indicates that the test results obtained from the at least one executed performance test lie outside the predefined range of the plurality of KPIs.

10. The system of claim 8, is configured to display an error message on the application interface of the user device and reperform the at least one performance test if the determined performance is the fail status.

11. The system of claim 8, is configured to display the test results obtained from the at least one executed performance test on the application interface of the user device if the determined performance is the pass status.

12. The system of claim 8, wherein the at least one selected site location identifier is selected from a group consisting of a Network Cell Identity (NCI), a Cell Identity (ID), and a Physical Cell ID (PCI).

13. The system of claim 8, wherein the at least one performance test is selected from a group consisting of a speed test, a video test, a web performance test, and a traceroute test.

14. The system of claim 8, wherein the GPS module is further configured to verify whether the user device is in proximity to the cellular site corresponding to the at least one site location identifier.

15. The system of claim 8, wherein the one or more processor(s) are further configured to:
refresh the application interface at a predefined interval to ensure updated matching of the at least one site location identifier with the set of device-measured identifiers.

16. The system (102) of claim 8, wherein the data acquisition module is further configured to:
periodically fetch and update the at least one site location identifier from the database; and
synchronize, in real-time, the at least one site location identifier with the set of device-measured identifiers to facilitate immediate execution of the at least one performance test upon matching.

17. The system of claim 8, wherein the processing engine is further configured to:
automatically record the test results for each performance test executed; and
compare the automatically recorded test results with historical data stored in the database to determine at least one of one or more trends and one or more performance improvement KPIs over time.

18. A user equipment (UE) configured to assess performance of cellular sites, the user equipment comprising:
a processor; and
a computer readable storage medium storing programming for execution by the processor, the programming including instructions to:
initiate a test sequence through an application interface of the UE for executing a plurality of performance tests on a cellular site;
receive a location of the UE from a global positioning system (GPS) module;
select at least one site location identifier associated with the UE based on the location of the UE and is further configured to determine whether the at least one selected site location identifier matches with a set of equipment-measured identifiers at a particular location;
execute at least one performance test in response to a match of the at least one site location identifier and the set of equipment-measured identifiers; and
determine a performance of the cellular site based on the at least one executed performance test by comparing test results obtained from the at least one executed performance test against a predefined range of a plurality of Key Performance Indicators (KPIs) stored within a database, wherein the plurality of KPIs includes a latency, a download speed, an upload speed, a reference signal received power (RSRP), and a signal-to-interference-plus-noise ratio (SINR).

19. The UE of claim 18, wherein the determined performance of the cellular site includes a pass status and a fail status, wherein:
the pass status indicates that the test results obtained from the at least one executed performance test lie in the predefined range of the plurality of KPIs; and
the fail status indicates that the test results obtained from the at least one executed performance test lie outside the predefined range of the plurality of KPIs.

20. (canceled)

21. (canceled)

22. (canceled)

23. A computer program product comprising a non-transitory computer-readable medium comprising instructions that, when executed by one or more processors, cause the one or more processors to perform:
initiate a test sequence through an application interface of a user device for executing a plurality of performance tests on a cellular site;
receive a location of the user device from a global positioning system (GPS) module;
select at least one site location identifier associated with the user device based on the location of the user device and determine whether the at least one selected site location identifier matches with a set of device-measured identifiers at a particular location;
execute at least one performance test in response to a match of the at least one site location identifier and the set of device-measured identifiers; and
determine a performance of the cellular site based on the at least one executed performance test by comparing test results obtained from the at least one executed performance test against a predefined range of a plurality of Key Performance Indicators (KPIs) stored within a database, wherein the plurality of KPIs includes a latency, a download speed, an upload speed, a reference signal received power (RSRP), and a signal-to-interference-plus-noise ratio (SINR)
